(19) United States
(12) Patent Application Publication
(10) Pub. No.: US 2024/0200342 A1
(43) Pub. Date: Jun. 20, 2024

(54) WALL SURFACE PUTTY SCRAPING APPARATUS

(71) Applicant: DATA FOUNTAIN PTY LTD., SHENZHEN (CN)

(72) Inventor: YU DENG, Shenzhen (CN)

(21) Appl. No.: 18/591,152

(22) Filed: Feb. 29, 2024

Related U.S. Application Data
(63) Continuation of application No. PCT/CN2022/115279, filed on Aug. 26, 2022.

(30) Foreign Application Priority Data
Aug. 31, 2021 (CN) 202111010764.5

(51) Int. Cl. E04F 21/08; B05C 17/10

(52) U.S. Cl. CPC E04F 21/08; B05C 17/10

(57) ABSTRACT

The present invention discloses a wall surface putty scraping apparatus, pertaining to the technical field of construction apparatuses and including a wall surface putty shaping assembly, a pressure adjusting assembly, and a multi-shaft mechanical arm assembly. The wall surface putty shaping assembly is configured to shape and flatten a putty paste applied to the wall surface; and the pressure adjusting assembly is connected with the wall surface putty shaping assembly. The multi-shaft mechanical arm assembly includes the mechanical arm and a pitching and rotating assembly, and the pitching and rotating assembly is connected with the pressure adjusting assembly.

### CROSS REFERENCE TO RELATED APPLICATION

This application is a continuation of International Patent Application No. PCT/CN2022/115279 with a filing date of Aug. 26, 2022, designating the United States, now pending, and further claims priority to Chinese patent application CN202111010764.5 with a filing date of Aug. 31, 2021. The content of the aforementioned applications, including any intervening amendments thereto, are incorporated herein by reference.

### TECHNICAL FIELD

The present invention relates to the technical field of construction apparatuses, and in particular, to a wall surface putty scraping apparatus.

### BACKGROUND

In the prior art, scrapping a wall surface putty is a heavy physical work in building decoration projects. On the one hand, high physical requirements are imposed on workers. On the other hand, because air pollution is caused in a process of scraping the putty, some harm can be further caused to human health. In addition, there are various problems such as low efficiency, poor scraping quality of the wall surface putty, and various potential safety hazards when the putty is scraped onto the wall surfaces manually, and therefore, such a situation needs to be improved urgently.

### SUMMARY

The present invention is intended to provide a wall surface putty scraping apparatus, where the wall surface putty scraping apparatus has a compact structure and can shape the wall surface putty conveniently and flexibly, to further effectively improve construction efficiency and reduce intensity of manual operation.

To achieve such an objective, the following technical solutions are used in the present invention.

A wall surface putty scraping apparatus is provided and includes: a wall surface putty shaping assembly, configured to shape and flatten a putty paste applied to the wall surface;
a pressure adjusting assembly, connected with the wall surface putty shaping assembly and configured to adjust pressure of the wall surface putty shaping assembly when pressing against the wall surface; and
a multi-shaft mechanical arm assembly, fitted with the pressure adjusting assembly and configured to adjust an angle and a position of the wall surface putty shaping assembly relative to the wall surface and drive the wall surface putty shaping assembly to move, where the multi-shaft mechanical arm assembly includes a mechanical arm and a pitching and rotating assembly fastened to the mechanical arm, and the pitching and rotating assembly is connected with the pressure adjusting assembly.

The pressure adjusting assembly includes an adjusting cavity, a support column fastened between upper and lower bottom surfaces of the adjusting cavity, multiple guide rods penetrating through the adjusting cavity, and a connecting plate arranged between ends of adjacent guide rods, and further includes a pair of threaded rods parallel to the guide rods, where both ends of the threaded rod are nested in threaded sleeves, a threaded sleeve at a front end is fixed to the connecting plate and is rotatively connected with the threaded rod, a threaded sleeve at a rear end penetrates through the bottom of the adjusting cavity and is threadedly connected with the threaded rod, a pressure sensor is disposed at a junction of the threaded sleeve at the front end and the connecting plate, a rear end of the threaded rod is nested in and fixed to a transmission wheel, a transmission motor is fixed to the bottom of the adjusting cavity, and an output end of the transmission motor is connected with the transmission wheel through belt transmission.

The wall surface putty shaping assembly includes a wall surface putty shaping scraper, a wall surface putty flattening scraper, and a wall surface putty edging scraper that are arranged side by side, and further includes a replaceable long roller and short roller, the long roller and the short roller are staggered, and the wall surface putty shaping scraper, the wall surface putty flattening scraper, and the wall surface putty edging scraper, or the long roller and the short roller are respectively hinged with corresponding connecting plates.

A driving shaft is disposed at an end of the mechanical arm, and the driving shaft is fastened to the pitching and rotating assembly.

A shaft sleeve is built in a bottom plate surface of the adjusting cavity, a connecting base is coaxially disposed on an inner bottom surface of the adjusting cavity, and the pitching and rotating assembly penetrates through the shaft sleeve and is fastened to the connecting base.

The pitching and rotating assembly includes a bracket, bearing bases disposed at two ends of the bracket, transmission shafts penetrating through the two bearing bases, a rotating motor disposed at one end of the transmission shaft, and a connecting member disposed at one end of the transmission shaft that is exposed from the bearing base, and the connecting member is fastened to the connecting base.

The bracket is provided with a hinge base fastened to the driving shaft, and the hinge base is located on one side of the adjusting cavity that is closer to the mechanical arm.

The mechanical arm includes a base, a hinge frame rotatively connected with the base, a first driving assembly for driving the hinge frame to rotate, a support arm pivoted with the hinge frame, an arc-shaped rack disposed at one end of the base, a second driving assembly meshed with the arc-shaped rack, a driving shaft disposed at one end of the mechanical arm that is farther away from the arc-shaped rack, and a third driving assembly that is disposed above the first driving assembly and that is configured to drive the driving shaft to rotate.

The hinge frame is pivoted with the support arm through a pivot shaft, first belt wheels are disposed at two ends of the pivot shaft that are exposed from the hinge frame, a second belt wheel is disposed on an inner side of the pivot shaft that is closer to the support arm, and third belt wheels are disposed at two ends of the driving shaft that are exposed from the support arm.

A power input end of the third driving assembly is connected with the second belt wheel through a first synchronization belt, and the first belt wheel is connected with the third belt wheel through a second synchronization belt.

Compared with the prior art, the present invention has the following beneficial effects:

The present invention provides the wall surface putty scraping apparatus, including the wall surface putty shaping assembly, the pressure adjusting assembly, and the multi-shaft mechanical arm assembly. The wall surface putty shaping assembly is configured to shape and flatten a putty paste applied to the wall surface; the pressure adjusting assembly is connected with the wall surface putty shaping assembly and configured to adjust pressure of the wall surface putty shaping assembly when pressing against the wall surface; and the multi-shaft mechanical arm assembly is fitted with the pressure adjusting assembly and configured to adjust the angle and the position of the wall surface putty shaping assembly relative to the wall surface and drive the wall surface putty shaping assembly to move. The multi-shaft mechanical arm assembly includes the mechanical arm and a pitching and rotating assembly fastened to the mechanical arm, and the pitching and rotating assembly is connected with the pressure adjusting assembly. The wall surface putty scraping apparatus designed with this structure can drive the wall surface putty shaping assembly to shape and flatten the putty paste applied to the wall surface conveniently and flexibly under driving action of the multi-shaft mechanical arm assembly in cooperation with the disposed pressure adjusting assembly, to further effectively improve construction efficiency and avoid various problems caused by manual operation.

### BRIEF DESCRIPTION OF DRAWINGS

To describe the technical solutions in the specific embodiments of the present invention or in the prior art more clearly, the following briefly describes the accompanying drawings required for describing the specific embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic diagram of an equiaxial side according to the present invention;

FIG. 2 is a diagram of an axial side with a mechanical arm removed according to the present invention; and

FIG. 3 is a schematic diagram of replacing a wall surface putty shaping assembly with a roller assembly according to the present invention.

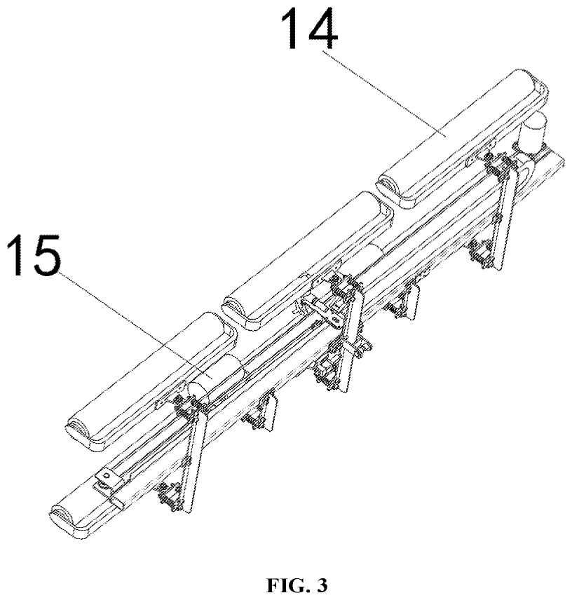

### REFERENCE SIGNS

1, wall surface putty shaping assembly; 11, wall surface putty shaping scraper; 12, wall surface putty flattening scraper; 13, wall surface putty edging scraper; 14, long roller; 15, short roller; 2, pressure adjusting assembly; 21, adjusting cavity; 22, pressure sensor; 23, support column; 24, guide rod; 25, connecting plate; 26, shaft sleeve; 27, connecting base; 28, threaded sleeve; 29, threaded rod; 210, transmission motor; 211, transmission wheel; 3, multi-shaft mechanical arm assembly; 31, mechanical arm; 311, base; 312, hinge frame; 313, first driving assembly; 314, support arm; 315, arc-shaped rack; 316, second driving assembly; 317, driving shaft; 318, third driving assembly; 3191, first belt wheel; 3192, second belt wheel; 3193, third belt wheel; 32, pitching and rotating assembly; 321, bracket; 3211, hinge base; 322, transmission shaft; 323, rotating motor; and 324, connecting member.

### DESCRIPTION OF EMBODIMENTS

The following clearly and completely describes the technical solutions in the present invention with reference to the accompanying drawings. Apparently, the described embodiments are some but not all of the embodiments of the present invention.

Generally, assemblies in the embodiments of the present invention as described and illustrated in the accompanying drawings herein can be arranged and designed in a variety of configurations. Therefore, the following detailed description of the embodiments of the present invention as provided in the accompanying drawings is not intended to limit the scope of the present invention but merely to represent selected embodiments of the present invention.

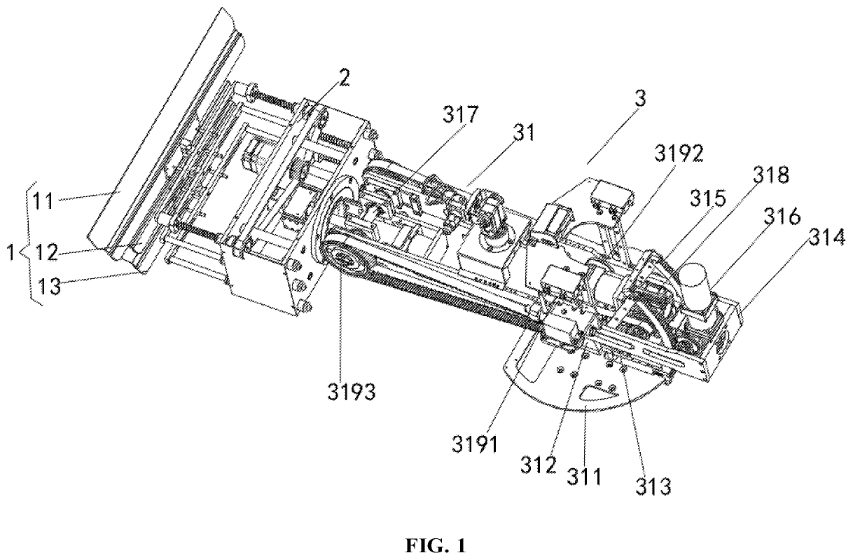

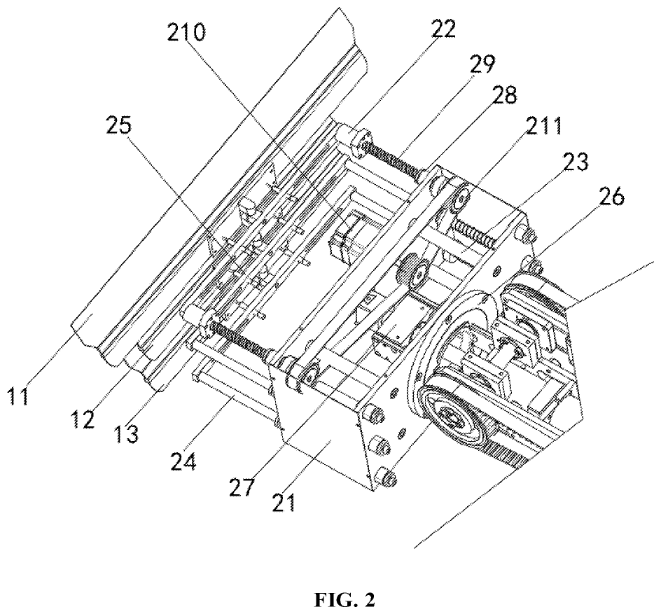

Next, as shown in FIG. 1 and FIG. 2, an embodiment of the present invention provides a wall surface putty scraping apparatus, including a wall surface putty shaping assembly 1, a pressure adjusting assembly 2, and a multi-shaft mechanical arm assembly 3. The wall surface putty shaping assembly 1 in this embodiment is mainly configured to shape and flatten a putty paste applied to the wall surface; the pressure adjusting assembly 2 is connected with the wall surface putty shaping assembly 1 and configured to adjust pressure of the wall surface putty shaping assembly 1 when pressing against the wall surface; and the multi-shaft mechanical arm assembly 3 is fitted with the pressure adjusting assembly 2 and configured to adjust an angle and a position of the wall surface putty shaping assembly 1 relative to the wall surface and drive the wall surface putty shaping assembly 1 to move. The wall surface putty scraping apparatus designed with this structure can drive the wall surface putty shaping assembly 1 to shape and flatten the putty paste applied to the wall surface through the driving of the multi-shaft mechanical arm assembly 3, and adjust the pressure between the wall surface putty shaping assembly 1 and the wall surface via the pressure adjusting assembly 2, to effectively improve construction efficiency, reduce labor intensity of manual operation, and reduce various disadvantages caused by manual operation.

Specifically, the multi-shaft mechanical arm assembly 3 in this embodiment includes a mechanical arm 31 and a pitching and rotating assembly 32 fastened to the mechanical arm 31, and the pitching and rotating assembly 32 is connected with the pressure adjusting assembly 2. More specifically, the mechanical arm 31 includes a base 311, a hinge frame 312 rotatively connected with the base 311, a first driving assembly 313 for driving the hinge frame 312 to rotate, a support arm 314 pivoted with the hinge frame 312, an arc-shaped rack 315 disposed at one end of the base 311, a second driving assembly 316 meshed with the arc-shaped rack 315, a driving shaft 317 disposed at one end of the mechanical arm 31 that is farther away from the arc-shaped rack 315, and a third driving assembly 318 that is disposed above the first driving assembly 313 and that is configured to drive the driving shaft 317 to rotate. The third driving assembly 318 is connected with the pitching and rotating assembly 32.

The mechanical arm 31 designed with this structure can drive the support arm 314 to rotate and pitch, and drive the pitching and rotating assembly 32 to pitch via the disposed first driving assembly 313, the second driving assembly 316, and the third driving assembly 318, thereby adjusting a construction position of the wall surface putty shaping assembly 1 relative to the wall surface.

Preferably, the first driving assembly 313, the second driving assembly 316, and the third driving assembly 318 in this embodiment each are provided with a motor and a transmission, so that each motor is controlled via an external electric control apparatus, to adjust a rotation speed and a pitching angle of the support arm in the mechanical arm 31, thereby adjusting a speed.

More specifically, the hinge frame 312 in this embodiment is pivoted with the support arm 314 through a pivot shaft, first belt wheels 3191 are disposed at two ends of the pivot shaft that are exposed from the hinge frame 312, a second belt wheel 3192 is disposed on an inner side of the pivot shaft that is closer to the support arm 314, and third belt wheels 3193 are disposed at two ends of the driving shaft 317 that are exposed from the support arm 314. A power input end of the third driving assembly 318 is connected with the second belt wheel 3192 through a first synchronization belt, and the first belt wheel 3191 is connected with the third belt wheel 3193 through a second synchronization belt.

In this embodiment, specific structural designs of the first driving assembly 313, the second driving assembly 316, and the third driving assembly 318 are commonly used in a related art. Details are not described herein.

More specifically, the pitching and rotating assembly 32 in this embodiment includes a bracket 321, bearing bases disposed at two ends of the bracket 321, transmission shafts 322 penetrating through the two bearing bases, a rotating motor 323 disposed at one end of the transmission shaft 322, and a connecting member 324 disposed at one end of the transmission shaft 322 that is exposed from the bearing base, and the connecting member 324 is fastened to the connecting base 27. More preferably, the bracket 321 is provided with a hinge base 3211 fastened to the driving shaft 317, and the hinge base 3211 is located on one side of the adjusting cavity 21 that is closer to the mechanical arm 31. Preferably, the hinge base 3211 on the bracket 321 in this embodiment is fastened to the driving shaft 317, so that the pitching and rotating assembly 32 is driven to pitch via rotation of the driving shaft 317.

More specifically, the pressure adjusting assembly 2 in this embodiment includes an adjusting cavity 21, a support column 23 fastened between upper and lower bottom surfaces of the adjusting cavity 21, multiple guide rods 24 penetrating through the adjusting cavity 21, and a connecting plate 25 arranged between ends of adjacent guide rods 24, and further includes a pair of threaded rods 29 parallel to the guide rods 24, where both ends of the threaded rod 29 are nested in threaded sleeves 28, a threaded sleeve 28 at a front end is fixed to the connecting plate 25 and is rotatively connected with the threaded rod 29, a threaded sleeve 28 at a rear end penetrates through the bottom of the adjusting cavity 21 and is threadedly connected with the threaded rod 29, a pressure sensor 22 is disposed at a junction of the threaded sleeve 28 at the front end and the connecting plate 25, a rear end of the threaded rod 29 is nested in and fixed to a transmission wheel 211, a transmission motor 210 is fixed to the bottom of the adjusting cavity 21, and an output end of the transmission motor 210 is connected with the transmission wheel 211 through belt transmission. In this embodiment, a mechanical compression spring structure formed by the threaded sleeve 28 and the threaded rod 29 is disposed, and as a result, when the wall surface putty shaping assembly 1 collides with the wall surface, the pressure sensor 22 is triggered, and therefore, the transmission motor 210 drives the transmission wheel 211 to rotate, the threaded rod 29 rotates accordingly, and the threaded sleeve 28 converts the rotation into a linear driving force for the wall surface putty shaping assembly 1 to move vertically relative to the adjusting cavity 21, so that impact between the wall surface putty shaping assembly 1 and the wall surface can be reduced, thereby exerting a better cushioning effect.

Preferably, for the guide rods 24 in this embodiment, a total of six guide rods 24 are disposed in pairs, and a connecting plate 25 is disposed at one end of the guide rod that is farther away from the adjusting cavity 21. Preferably, in order to facilitate a connection and fixation of the pitching and rotating assembly 32 with the pressure adjusting assembly 2, a shaft sleeve 26 is built in a plate surface of the adjusting cavity 21 in this embodiment, a connecting base 27 is coaxially disposed on an inner bottom surface of the adjusting cavity 21, and the pitching and rotating assembly 32 penetrates through the shaft sleeve 26 and is fastened to the connecting base 27.

Through the foregoing structural design, the wall surface putty shaping assembly 1 can be driven to rotate around the transmission shaft 322 in the pitching and rotating assembly 32 under action of the pitching and rotating assembly 32, which further facilitates synchronous rotation of the wall surface putty shaping assembly 1, thereby adjusting a construction position of the wall surface putty shaping assembly 1.

In addition, the wall surface putty shaping assembly 1 in this embodiment includes a wall surface putty shaping scraper 11, a wall surface putty flattening scraper 12, and a wall surface putty edging scraper 13 that are arranged side by side and that are respectively hinged with corresponding connecting plates 25 on the pressure adjusting assembly 2, so that shaping of the wall surface putty can be completed simultaneously in this way, thereby effectively improving construction efficiency of the wall surface putty. The wall surface putty shaping scraper 11 and the wall surface putty flattening scraper 12 can be replaced with a long roller 14 and a short roller 15 correspondingly, the long roller 14 and the short roller 15 are staggered and are also hinged with the connecting plates. In this embodiment, the wall surface putty shaping assembly 1 can be replaced with a wall surface putty roller coating assembly formed by the long roller 14 and the short roller 15, to implement roller coating of the wall surface and two different functions of the same mechanism, which is applicable to various construction manners of the wall surface putty. In addition, in this embodiment, specific structural settings of the wall surface putty shaping scraper 11, the wall surface putty flattening scraper 12, and the wall surface putty edging scraper 13, or the long roller 14 and the short roller 15 are commonly used in a related art. Details are not described herein.

Finally, it should be noted that the foregoing embodiments are merely intended for describing the technical solutions of the present invention, but not for limiting the present invention. Although the present invention is described in detail with reference to the foregoing embodiments, a person of ordinary skill in the art should understand that they may still make modifications to the technical solutions described in the foregoing embodiments or make equivalent replacements to some or all technical features thereof, without departing from the scope of the technical solutions of the embodiments of the present invention.

The present invention discloses a wall surface putty scraping apparatus, pertaining to the technical field of construction apparatuses and including a wall surface putty shaping assembly, a pressure adjusting assembly, and a multi-shaft mechanical arm assembly. The wall surface putty shaping assembly is configured to shape and flatten a putty paste applied to the wall surface; and the pressure adjusting assembly is connected with the wall surface putty shaping assembly. The multi-shaft mechanical arm assembly includes the mechanical arm and a pitching and rotating assembly, and the pitching and rotating assembly is connected with the pressure adjusting assembly. The wall surface putty scraping apparatus designed with this structure can drive the wall surface putty shaping assembly to shape and flatten the putty paste applied to the wall surface conveniently and flexibly under driving action of the multi-shaft mechanical arm assembly in cooperation with the disposed pressure adjusting assembly, to further effectively improve construction efficiency and avoid various problems caused by manual operation.

1. A wall surface putty scraping apparatus, comprising:
a wall surface putty shaping assembly, configured to shape and flatten a putty paste applied to the wall surface;
a pressure adjusting assembly, connected with the wall surface putty shaping assembly and configured to adjust pressure of the wall surface putty shaping assembly when pressing against the wall surface; and
a multi-shaft mechanical arm assembly, fitted with the pressure adjusting assembly and configured to adjust an angle and a position of the wall surface putty shaping assembly relative to the wall surface and drive the wall surface putty shaping assembly to move, wherein the multi-shaft mechanical arm assembly comprises a mechanical arm and a pitching and rotating assembly fastened to the mechanical arm, and the pitching and rotating assembly is connected with the pressure adjusting assembly.

2. The wall surface putty scraping apparatus according to claim 1, wherein the pressure adjusting assembly comprises an adjusting cavity, a support column fastened between upper and lower bottom surfaces of the adjusting cavity, multiple guide rods penetrating through the adjusting cavity, and a connecting plate arranged between ends of adjacent guide rods, and further comprises a pair of threaded rods parallel to the guide rods, wherein both ends of the threaded rod are nested in threaded sleeves, a threaded sleeve at a front end is fixed to the connecting plate and is rotatively connected with the threaded rod, a threaded sleeve at a rear end penetrates through the bottom of the adjusting cavity and is threadedly connected with the threaded rod, a pressure sensor is disposed at a junction of the threaded sleeve at the front end and the connecting plate, a rear end of the threaded rod is nested in and fixed to a transmission wheel, a transmission motor is fixed to the bottom of the adjusting cavity, and an output end of the transmission motor is connected with the transmission wheel through belt transmission.

3. The wall surface putty scraping apparatus according to claim 2, wherein the wall surface putty shaping assembly comprises a wall surface putty shaping scraper, a wall surface putty flattening scraper, and a wall surface putty edging scraper that are arranged side by side, and further comprises a replaceable long roller and short roller, the long roller and the short roller are staggered, and the wall surface putty shaping scraper, the wall surface putty flattening scraper, and the wall surface putty edging scraper, or the long roller and the short roller are respectively hinged with corresponding connecting plates.

4. The wall surface putty scraping apparatus according to claim 2, wherein a driving shaft is disposed at an end of the mechanical arm, and the driving shaft is fastened to the pitching and rotating assembly.

5. The wall surface putty scraping apparatus according to claim 4, wherein a shaft sleeve is built in a bottom plate surface of the adjusting cavity, a connecting base is coaxially disposed on an inner bottom surface of the adjusting cavity, and the pitching and rotating assembly penetrates through the shaft sleeve and is fastened to the connecting base.

6. The wall surface putty scraping apparatus according to claim 5, wherein the pitching and rotating assembly comprises a bracket, bearing bases disposed at two ends of the bracket, transmission shafts penetrating through the two bearing bases, a rotating motor disposed at one end of the transmission shaft, and a connecting member disposed at one end of the transmission shaft that is exposed from the bearing base, and the connecting member is fastened to the connecting base.

7. The wall surface putty scraping apparatus according to claim 6, wherein the bracket is provided with a hinge base fastened to the driving shaft, and the hinge base is located on one side of the adjusting cavity that is closer to the mechanical arm.

8. The wall surface putty scraping apparatus according to claim 4, wherein the mechanical arm comprises a base, a hinge frame rotatively connected with the base, a first driving assembly for driving the hinge frame to rotate, a support arm pivoted with the hinge frame, an arc-shaped rack disposed at one end of the base, a second driving assembly meshed with the arc-shaped rack, a driving shaft disposed at one end of the mechanical arm that is farther away from the arc-shaped rack, and a third driving assembly that is disposed above the first driving assembly and that is configured to drive the driving shaft to rotate.

9. The wall surface putty scraping apparatus according to claim 8, wherein the hinge frame is pivoted with the support arm through a pivot shaft, first belt wheels are disposed at two ends of the pivot shaft that are exposed from the hinge frame, a second belt wheel is disposed on an inner side of the pivot shaft that is closer to the support arm, and third belt wheels are disposed at two ends of the driving shaft that are exposed from the support arm.

10. The wall surface putty scraping apparatus according to claim 9, wherein a power input end of the third driving assembly is connected with the second belt wheel through a first synchronization belt, and the first belt wheel is connected with the third belt wheel through a second synchronization belt.
